(19) United States
(12) Patent Application Publication
(10) Pub. No.: US 2016/0167931 A1
(43) Pub. Date: Jun. 16, 2016

(54) AUTOMATED DEVICE FOR OPENING AND CLOSING METAL GOODS-TRANSPORTATION BOXES FOR STOWAGE ON SHIPS

(71) Applicant: Pedro Paulo Fatorelli CARNEIRO, (US)

(72) Inventor: Pedro Paulo Fatorelli CARNEIRO, Vila Velha (BR)

(21) Appl. No.: 14/649,923

(22) PCT Filed: Jan. 23, 2013
(86) PCT No.: PCT/BR2013/000032

§ 371 Date: Jan. 16, 2016

(30) Foreign Application Priority Data
Dec. 6, 2012 (BR) 102012031119-4

(51) Int. Cl. B66C 3/06; B63B 25/02; B66C 3/16

(52) U.S. Cl. CPC B66C 3/06; B66C 3/16; B63B 25/02

(57) ABSTRACT

Automated device for opening and closing metal goods-transportation boxes for stowage on ships relates to an automated device designed to open and close metal goods-transportation boxes for stowage on ships that obviates the need for storage silos close to the quay of the port and the conveyer belts and accessories thereof for loading the ship.

### FIELD

The present invention refers to the automated device intended for opening and closing metal goods-transportation boxes for stowage on ships, eliminating the need for storage silos near the quay of the port as well as the conveyor belts and accessories thereof for loading the ship. Currently, goods such as grains, fertilizers and the like are loaded onto ships through large load moving structures present at the ports, such as silos and conveyor belts, occupying a large area for stocking and moving these goods. With a great demand for shipping, exporters are limited to the ports' storage capacities. Alternatively, exporters stock goods at locations far from ports.

### BACKGROUND

Storage outside of ports requires the exporter to handle and transport these goods in bags or containers, thus limiting the transport of merchandise to ships with proper features for this type of transport or in difficult-to-operate bendable boxes. In a conventional method, these boxes are loaded with goods on the exporter's stockyard and taken on trucks to the port and where they are hoisted by the ship's crane through two central eye bolts connected to the crane's wires. Then it is taken to the ship's hold, supported at the bottom of the hold or on another load already stowed and then an operator repositions these hoist wires attaching them to the eye bolt extremities of the box so that the ship's crane progresses opening when hoisting it again.

This method requires time for repositioning the box's hoist wires so that it will open. This conventional method has the added inconvenience of needing an operator inside the ship's hold to reposition the hoist wires, which is a risky operation, and the box needs to be supported while loading, so that the operator can reposition these hoist wires.

It is also not possible to close this box inside the ship's hold since it would need to be supported over the load to reposition the hoist wires, which would again cause the goods to enter the box when closing it. Since this box is open when it leaves the hold, the port quay could be contaminated by wastes from aggregate goods, which loosen from the box when moving the box back to the truck.

### SUMMARY

Provided is the automated device intended for opening and closing metal goods-transportation boxes for stowage on ships completely eliminates the difficulties of the conventional method presented above comprising special boxes (3) and (4) and an automatic “spreader” (1). The automatic “spreader” has two movable wires (8) and (9) that lower and lift the boxes and two wires (14) and (15) that are used to pull the extremities of these boxes as they are lowered and to open the two boxes, as shown in FIG.: 06. The boxes are closed as they are lifted. There are also covers 4 and 5. The device provides advantages when used, such as speed of operation, there is no need for an operator in the hold of the ship, since the boxes are opened and closed by actuating the system for lowering or lifting the boxes by means of the automatic “spreader”, which can be actuated remotely, using buttons.

### BRIEF DESCRIPTION OF THE FIGURES

FIG. 01: presents a side view of the automated device intended for opening and closing metal goods-transportation boxes for stowage on ships in the idle position;

FIG. 02: presents a view of the spreader;

FIG. 03: presents a front view of the box with closed covers;

FIG. 04: presents a surface view of the box highlighting the set of pistons;

FIG. 05: presents a front view of the box with open covers;

FIG. 06: presents a side view of the automated device intended for opening and closing metal goods-transportation boxes for stowage on ships in operation;

FIG. 07: presents a detailed design of the groove where the ones that will hoist the covers will pass.

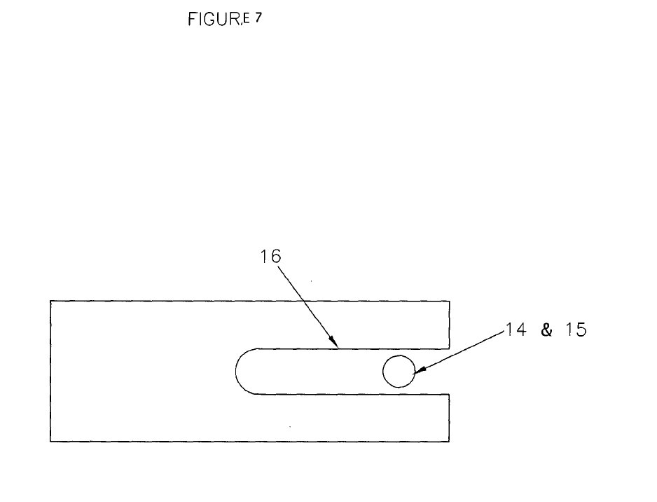

### DETAILED DESCRIPTION

As can be noted in the figures, the automated device intended for opening and closing metal goods-transportation boxes for stowage on ships is composed of a set of portable covers (4) and (5), whose functions will be noted throughout this report.

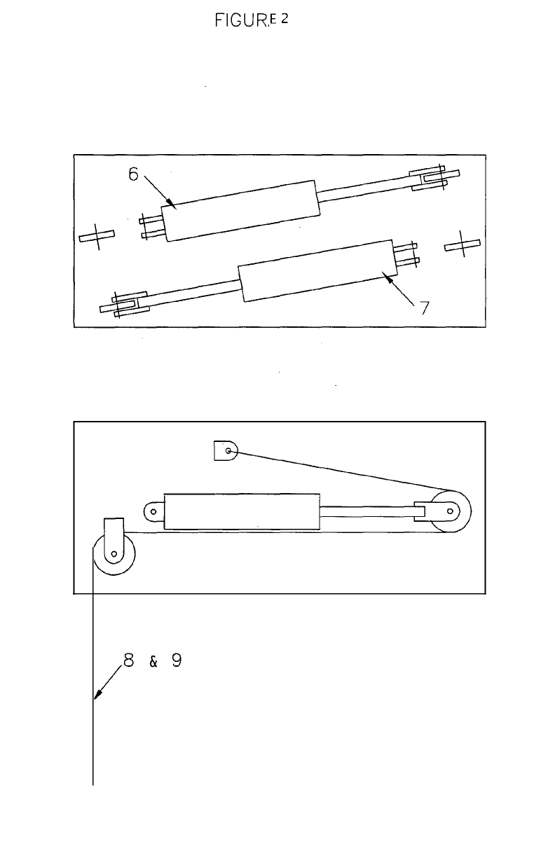

The automatic “spreader” (1) possesses two cylinders (6) and (7) cross-sections set parallel between themselves according to FIG. 02, with a return pulley at each extremity of its rods in order to bend the course of the lowering or hoist wire (FIG. 02).

These cylinders effect the opening and closing operation of the box and are set in motion through a hydraulic pump connected to an electric or combustion engine.

Optionally this system can be constructed with a gear motor and wire rope drum, thus substituting the hydraulic cylinder. The box is opened when the wires (8) and (9) are lowered, while it is closed as the same wires (8) and (9) are raised.

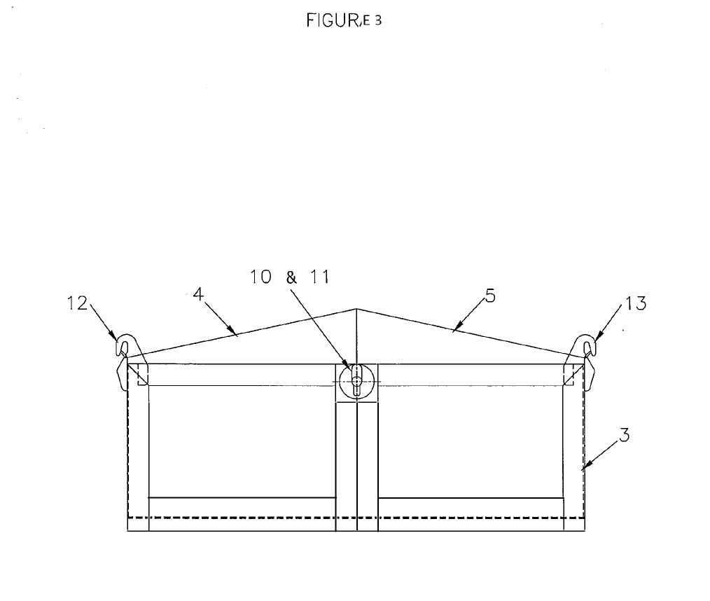

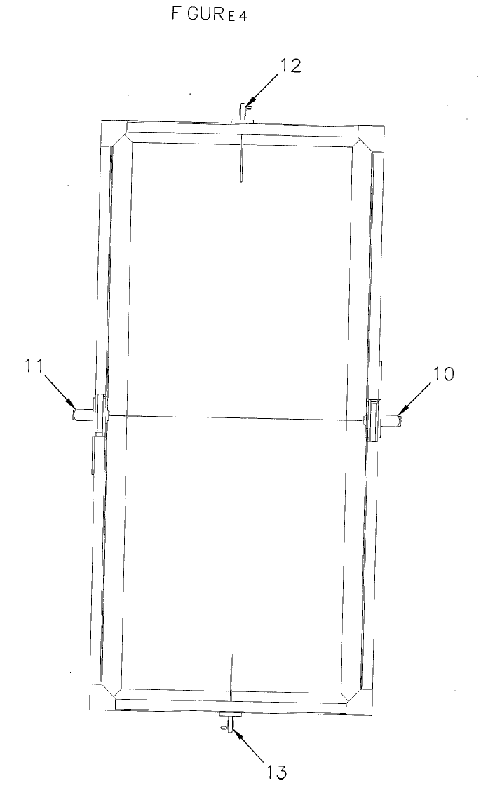

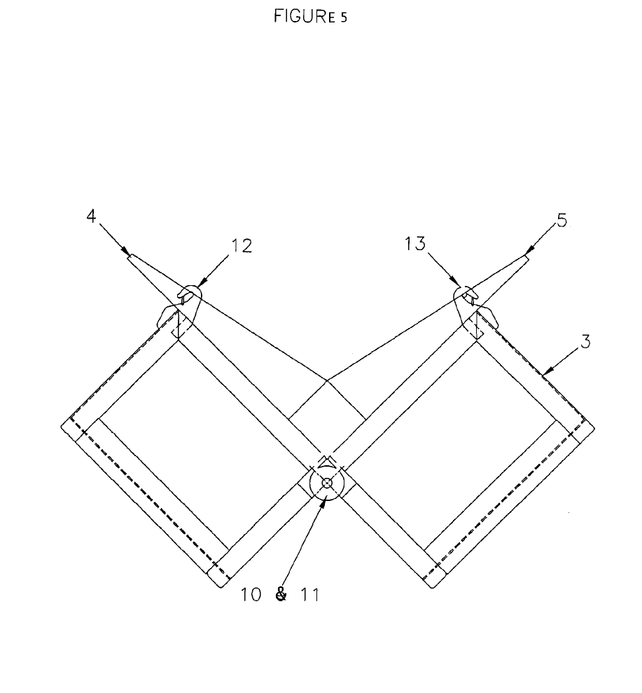

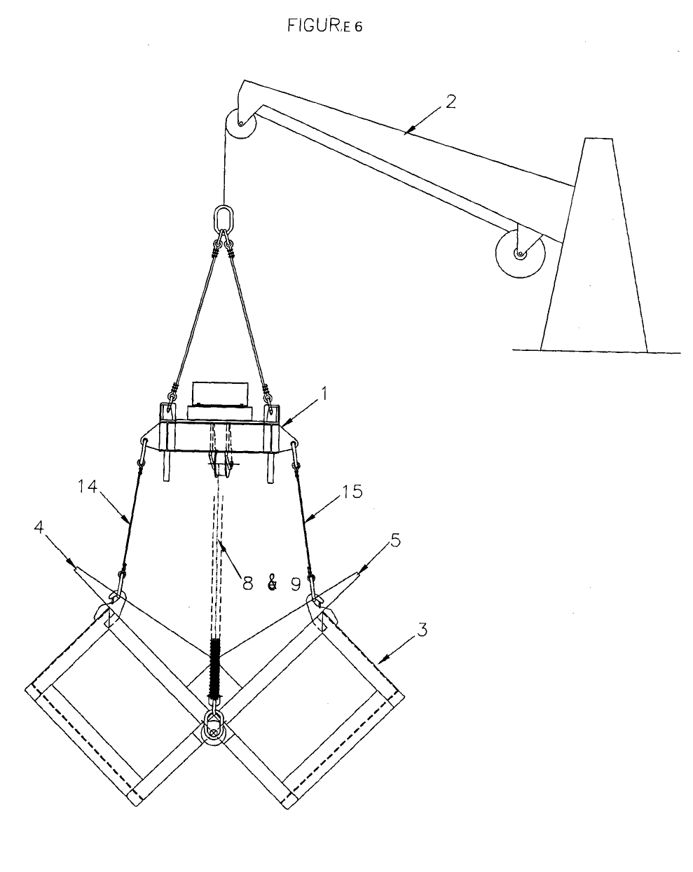

The boxes presented in attached FIGS. 03, 04 and 05, close with the hoisting of the wires (8) and (9), which are connected to them between the boxes in items (10) and (11) and open when lowered. There are two wires (14) and (15) which connect the boxes at their two other extremities (12) and (13) and these wires strain and start to traction when lowering the two central wires (8) and (9), which stop traction after a while of lowering and thus cause the box to open as seen in FIG. 06. Thus, the material drains by gravity through the formed inclined surfaces without leaving any wastes adhered to the boxes.

The boxes' two covers (4) and (5), which open a little when opening them and which close completely when wires (8) and (9) rise and which consequently causes the boxes to close. There are grooves present in these covers to prevent contact with wires (14) and (15) connected to extremities (12) and (13).

Located within the automatic “spreader” (FIG. 02) are the hydraulic systems (6) and (7), engine and pumps, thus moving wires (8) and (9) is done by remotely switching the button, which lowers the wires or raises them. When lowering wires (8) and (9) inside of the ship, after a while wires (14) and (15) are then tractioned and (8) and (9) ease. Thus, the boxes open and empty as can be seen in FIG. 06. When raising wires (8) and (9) the boxes close completely, covers (6) and (7) also closed and the box is then removed from the ship, through the bridge of the ship.

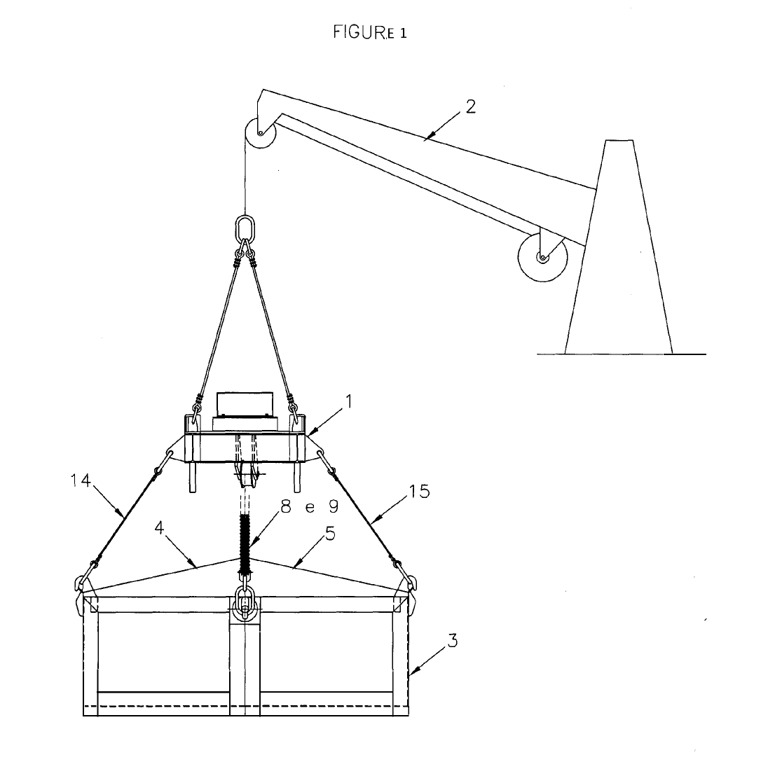

As can be noted from the text above, the device known as an automatic “spreader” (1) operated by a remote control, which runs the opening and closing operations of the boxes (3) in any place that they may be, being the same one hoisted by the ship's crane (2) (FIG. 01 and FIG. 06), which then has the sole function of hoisting and lowering the set of boxes (3) and the “spreader” (1). With the automated device intended for opening and closing metal goods-transportation boxes for stowage on ships, there is no need to keep an operator inside the hold and eliminates the need for the box to support at the bottom of the hold or in the actual load of the ship to open or close the box and it leaves closed and clean from the hold of the ship and thus eliminates any contamination both at the port quay, as well as in any another environment. The operation time is greatly reduced with this method, thus increasing the productivity of the shipping operation

What is claimed is:

1. An automated device for opening and closing metal goods-transportation boxes for stowage on ships using an automatic “spreader” (1) and special boxes (3) wherein
(a) the automatic “spreader” comprises a mechanical/hydraulic system, which raises and lowers wires (8) and (9)
(b) when lowering wires (8) and (9) boxes opening through wires (14) and (15) are tractioned, while wires (8) and (9) are slightly loose and no longer traction points (10) and (11) of said boxes (3) whereby goods contained in the boxes drain through the lower inclined surfaces of the boxes and do not leave wastes in said boxes And (c) when raising wires (8) and (9), said wires are tractioned, while wires (14) and (15) ease and are no longer tractioned, whereby the boxes are completely closed, and then removed from the ship.

2. The automated device for opening and closing metal goods-transportation boxes for stowage on ships of claim 1, further comprising portable covers and (4) and (5), which slightly move in opening the boxes and which later also close completely in raising the boxes.

3. The automated device for opening and closing metal goods-transportation boxes for stowage on ships of claim 1, wherein a groove passes through wires (14) and (15) without touching them when moving the covers;

4. The automated device for opening and closing metal goods-transportation boxes for stowage on ships of claim 1, further comprising hydraulical cylinders (61 and (7) or gear motor and wire rope drum, wherein said hydraulical cylinders (6) and (7) or gear motor and wire rope drum are operated through an electric or combustion engine which drives an oil pump to actuate the hydraulical pistons present in each cylinder and which drives wires (8) and (9), raising them or lowering them, according to a remote command.

5. The automated device for opening and closing metal goods-transportation boxes for stowage on ships of claim 1, wherein the electric or combustion engine is directly connected to said automated device or connected through an axle speed reduction box for moving the wires or steel chains in one or another direction upwards and downwards through pulleys, or directly.
